(19) United States
(12) Patent Application Publication
(10) Pub. No.: US 2020/0209857 A1
(43) Pub. Date: Jul. 2, 2020

(54) MULTIMODAL CONTROL SYSTEM FOR SELF DRIVING VEHICLE

(71) Applicant: Uber Technologies, Inc., San Francisco, CA (US)

(72) Inventors: Nemanja Djuric, Pittsburgh, PA (US); John Houston, Pittsburgh, PA (US); Jeffrey Schneider, Pittsburgh, PA (US)

(21) Appl. No.: 16/268,337

(22) Filed: Feb. 5, 2019

Related U.S. Application Data
(60) Provisional application No. 62/786,707, filed on Dec. 31, 2018.

(51) Int. Cl. G05D 1/00; G05D 1/02

(52) U.S. Cl. CPC G05D 1/0088; G05D 2201/0213; G05D 1/0221

(57) ABSTRACT

According to examples, a self-driving vehicle (“SDV”) is operable to select one of (i) an autonomous localization mode, in which the SDV autonomously operates using a localization map, or (ii) an autonomous neural network mode, in which the SDV uses a neural network component that implements one or more machine learning models. The SDV can autonomously operate on at least a segment of a planned route using the selected one of the autonomous localization mode or the autonomous neural network mode.

### RELATED AND CROSS-REFERENCED APPLICATIONS

This application claims benefit of priority to Provisional U.S. Patent Application No. 62/786,707, filed Dec. 31, 2018; the aforementioned priority application hereby being incorporated by reference.

This application also incorporates by reference in their respective entirety each of U.S. patent application Ser. No. 15/450,268, titled “HYBRID TRIP PLANNING FOR AUTONOMOUS VEHICLES”, filed on Mar. 6, 2017, and U.S. Provisional Application No. 62/379,162, entitled “HYBRID AUTONOMY ROUTING,” filed on Aug. 24, 2016.

### BACKGROUND

Neural networks are being applied in various industries to improve decision-making and provide solutions to a wide assortment of computational tasks that have been proven problematic or excessively resource intensive with traditional rule-based programming. For example, speech recognition, audio recognition, task-oriented activities (e.g., gaming activities such as chess and checkers), problem solving, and question answering have seen breakthrough advancements through the use of neural networks and deep learning. These networks can employ multi-layered, non-linear processing and adaptation techniques that can offer significant efficiencies in certain computing functions, especially when certain cognitive human tasks are being substituted or improved upon.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example self-driving vehicle implementing a neural network control system, as described herein;

FIG. 2 is a block diagram illustrating an example neural network control system utilized in connection with a self-driving vehicle, according to examples described herein;

FIG. 3 shows an example of an autonomously controlled self-driving vehicle utilizing sensor data to navigate an environment in accordance with example implementations;

FIG. 4 is a flow chart describing an example method of autonomously operating a self-driving vehicle through use of a neural network, according to examples described herein;

FIG. 5 is a lower level flow chart describing an example method of autonomously operating a self-driving vehicle through use of a neural network, according to examples described herein;

FIG. 6 is a block diagram illustrating an example of a multimodal autonomous control system for an SDV.

FIG. 7 illustrates a method for operating an SDV using a multimodal control system; and

FIG. 8 is a block diagram illustrating a computer system for a self-driving vehicle upon which examples described herein may be implemented.

### DETAILED DESCRIPTION

Certain autonomous driving technologies involve the use of very detailed and preprocessed localization maps that an autonomous vehicle's control system can continuously compare to a live sensor view in order to operate the vehicle through road traffic and detect any potential hazards. As an example, navigation techniques for self-driving vehicles can involve setting an endpoint location, determining a route from a current location to the endpoint, and performing dynamic localization and object detection to safely operate the vehicle to the endpoint. While providing adequate safety, such methods can be excessively labor-intensive, requiring pre-recorded street view maps on the roads in a given region, and processing those maps to establish localization parameters, such as lane positions, static objects (e.g., trees, buildings, curbs, parking meters, fire hydrants, etc.), objects of interest (e.g., traffic signals and signs), dynamic objects (e.g., people, other vehicles, etc.), and the like. Furthermore, in order to operate safely in variable conditions, a suite of sensors is typically required composed of combinations of LIDAR, radar, stereoscopic and monocular cameras, IR sensors, and even sonar. However, drawbacks to such autonomous driving methods have become increasingly evident. For example, in order to implement these methods in new driving areas, new localization maps must be recorded, processed, and uploaded to the SDVs.

To address the shortcomings of the current methodologies, disclosed herein are examples of a neural network system for autonomous control of a self-driving vehicle (SDV). According to examples provided herein, the neural network system can implement a machine learning model (e.g., supervised learning) to learn and improve autonomous driving in public road environments. Certain neural network (or deep learning) methodologies can involve lane-keeping, or maintaining the SDV within a certain lane while a data processing system implements traditional instruction-based control of the SDV's control mechanisms (e.g., acceleration, braking, and steering systems). According to examples provided herein, the neural network system can establish or otherwise be inputted with a destination location in local coordinates relative to the SDV (e.g., in an inertial reference frame), and can establish or otherwise be inputted with one or more navigation points in a forward operational direction of the SDV along a route to the destination (e.g., in global coordinates and affixed to the non-inertial reference frame of the SDV). For example, each of the one or more navigation points can comprise two-dimensional coordinates having values that vary in relation to the destination location (e.g., Cartesian x-y coordinate values, or distance and angle values in polar coordinates). In variations, the navigation points can be established in three-dimensional space (e.g., Cartesian or spherical coordinate systems). Accordingly, the neural network utilizes the coordinate values of the navigation point(s)—established persistently ahead of the SDV along the route—to make decisions with regards to acceleration, braking, steering, lane selection, and signaling.

In certain aspects, the neural network system can operate as a control system of the SDV, on processing resources external to the SDV (communicating decisions or control commands to the SDV over one or more networks), or can operate as a combination of both. In various implementations, the SDV can include a sensor array comprising any number of sensors and sensor types, such as LIDAR, stereoscopic and/or monocular cameras, radar, sonar, certain types of proximity sensors (e.g., infrared sensors), and the like. In navigating the SDV to a destination, the neural network can operate the SDV's acceleration, braking, and steering systems along the route, relying on both the navigation point(s) and sensor data from the SDV's sensor array in order to not only maintain the SDV within a respective lane, but to also react or make decisions with respect to lane selections, traffic signals, pedestrians, other vehicles, bicyclists, obstacles, road signs, and the like. Along these lines, the neural network system can undergo supervised learning through a training phase, a test phase, and eventually an implementation phase in which the neural network operates the SDV safely on public roads and highways to transport passengers to sequential destinations (e.g., once the neural network meets a standardized safety threshold).

In some examples, the neural network system can utilize a satellite receiver, such as a global position system (GPS) module, to set the navigation points in global coordinates and the destination location in local coordinates. According to examples, the neural network system can utilize the satellite receiver to set positioning signals (i.e., the navigation points) at predetermined distances ahead of the SDV (or temporally ahead of the vehicle based on traffic and speed). In variations, the navigation points can be set by a backend management system at persistent distances ahead of the SDV along the route. An example backend route management system can comprise a network-based transport system that manages on-demand transportation arrangement services, such as those provided by Uber Technologies, Inc., of San Francisco, Calif.

Examples described herein recognize that a precise navigation point signal can result in an overfitting problem by the neural network system, in which the neural network system becomes too dependent on the navigation points, and thus begins to blindly follow them as opposed to relying on the sensor data for decision-making. In order to address the risk of overfitting, the neural network system can introduce noise to the positioning signals corresponding to the navigation points to cause the neural network to rely more on image data or sensor data, reducing the potential for overreliance on the navigation points. The noise can reduce the accuracy of the positioning signal (e.g., boosting horizontal error), causing the neural network system to process the sensor data, stabilizing the SDV's road performance, and making the neural network more robust.

A key aspect to the neural network system is the utilization of the navigation points as “carrots” that enable the neural network system to perform additional autonomous driving tasks on top of simple lane-keeping, although lane-keeping may be significantly improved through implementation of examples described herein. In various aspects, the neural network system can track the navigation points—which themselves follow the route to the destination—to select lanes, make turns on new roads, and respond to events, traffic signals, road signs, weather conditions, and other contingencies. Furthermore, in order to increase robustness, the distance or time of the navigation point(s) ahead of the vehicle, the number of navigation points, and the amount of noise introduced to the navigation point signals can be adjusted. Thus, in one example, the neural network system establishes a pair of navigation points in series along the route ahead of the SDV (e.g., a first point at 50 meters and a second point at 100 meters). In operating the SDV along the route, the neural network system can continuously compare the coordinate values of each navigation signal to make decisions with regard to acceleration, steering, and braking. In further examples, the neural network system can further dynamically compare the coordinate values of the navigation points to the coordinate of the SDV itself in order to determine an immediate route plan.

For example, each of the vehicle's coordinates and the coordinates of the navigation points can be established in global coordinates, such that the coordinate values of each may be readily compared. The neural network system can take the destination in local coordinates as an additional input. The nature of the compared coordinate values (e.g., whether the individual x-values and y-values of each coordinate are converging or diverging) can indicate to the neural network system whether a turn is upcoming or the nature of the overall route to the destination. Accordingly, in tracking or following the navigation points, the neural network can create a series of successive high level route plans (e.g., for the next fifty or one hundred meters of the overall route). The neural network system may conjunctively utilize the sensor data to safely autonomously operate the SDV along each successive route plan.

Still further, in other examples, an SDV is operable to select one of (i) an autonomous localization mode, in which the SDV autonomously operates using a localization map, or (ii) an autonomous neural network mode, in which the SDV uses a neural network component that implements one or more machine learning models. The SDV can autonomously operate on at least a segment of a planned route using the selected one of the autonomous localization mode or the autonomous neural network mode.

Among other benefits, the examples described herein achieve a technical effect of improving upon current autonomous driving methodologies by utilizing neural networks to overcome the challenges apparent in rule-based programming for autonomous driving, such as the need to record detailed surface maps in all areas of operation. Using neural network technology enables the use of readily available maps (e.g., coarse road network maps) as route references, while the neural network system utilizes the navigation points and sensor data to autonomously operate the vehicle to the destination. Thus, given a destination, the neural network system can establish a route and track persistent navigation points to operate the vehicle to the destination.

Additionally, in some examples, autonomous vehicles can utilize neural networks to implement an alternative autonomous mode for controlling the SDV. A control system for an autonomous vehicle may utilize separate control systems to implement alternative autonomous modes for SDVs. In such examples, a neural network control sub-system can supplement or co-exist with an autonomous control sub-system that utilizes localization maps. In locations where localization maps are sparse, out-of-date, or where conditions (e.g., weather, traffic) disfavor localization processes, the SDV can seamlessly switch from a localization-based mode (e.g., using localization maps) to a neural-network based mode, where localization maps and/or processes can be avoided.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, virtual reality (VR) or augmented reality (AR) computers, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as those carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

Numerous examples are referenced herein in context of an autonomous vehicle (AV) or self-driving vehicle (SDV). An AV or SDV refers to any vehicle which is operated in a state of automation with respect to steering and propulsion. Different levels of autonomy may exist with respect to AVs and SDVs. For example, some vehicles may enable automation in limited scenarios, such as on highways, provided that drivers are present in the vehicle. More advanced AVs and SDVs can drive without any human assistance from within or external to the vehicle.

Furthermore, numerous examples described herein reference a “neural network,” “deep learning,” or “deep neural network.” Such terms may be used throughout the disclosure interchangeably to represent the execution of one or more machine learning models (e.g., a set of algorithms) that utilize multiple processing layers (e.g., comprising any number of linear and/or non-linear mappings or transformations) to infer, adapt, confirm, and/or make decisions based on any number of inputs. In the context of the present disclosure, a “neural network” or “deep neural network” is provided that implements one or more machine learning models that causes the network to operate the control mechanisms of a vehicle autonomously (e.g., the acceleration, braking, steering, and/or auxiliary systems of the vehicle). Such examples can receive multiple inputs corresponding to navigation points having global coordinate values, the vehicle's own global coordinates, a succession of destination locations (e.g., in local coordinates), and sensor data that provides a sensor view of the surroundings of the vehicle (e.g., in a forward operational direction). Furthermore, such examples can be trained, tested, and implemented to perform human cognitive functions with respect to maintaining the vehicle within a lane, and making practical, cautious, and safe decisions with respect to changing lanes, avoiding hazards or hazard threats, following traffic rules and regulations, and safely making turns to autonomously drive the vehicle on test roads and public roads and highways.

System Description

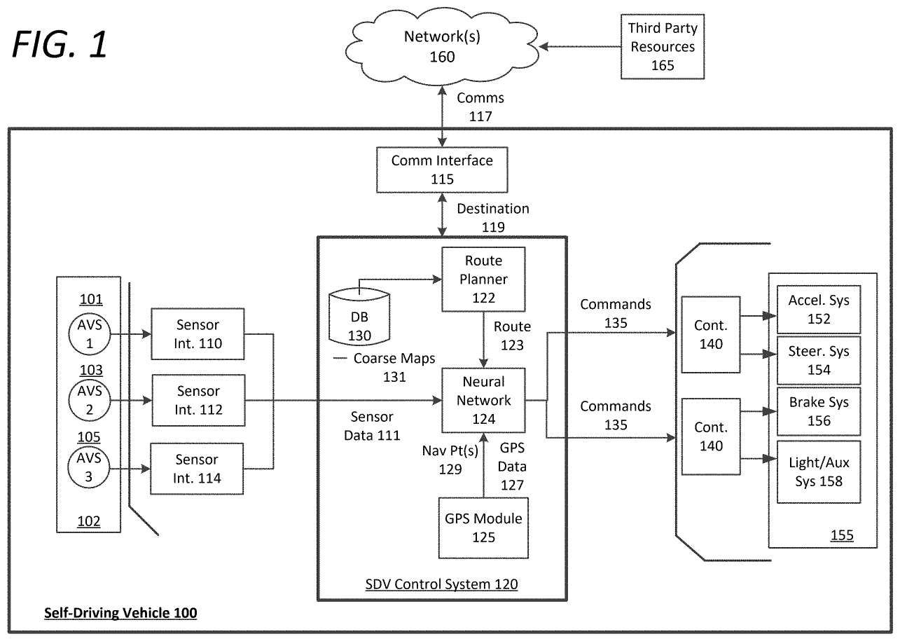

FIG. 1 is a block diagram illustrating an example self-driving vehicle implementing a neural network control system, as described herein. In an example of FIG. 1, a control system 120 can autonomously operate the SDV 100 in a given geographic region for a variety of purposes, including transport services (e.g., transport of humans, delivery services, etc.). In examples described, the SDV 100 can operate without human control. For example, the SDV 100 can autonomously steer, accelerate, shift, brake, and operate lighting components. Some variations also recognize that the SDV 100 can switch between an autonomous mode, in which the SDV control system 120 autonomously operates the SDV 100, and a manual mode in which a driver takes over manual control of the acceleration system 152, steering system 154, and braking system 156.

According to some examples, the control system 120 can utilize specific sensor resources in order to intelligently operate the SDV 100 in a variety of driving environments and conditions. For example, the control system 120 can operate the vehicle 100 by autonomously operating the steering, acceleration, and braking systems 152, 154, 156 of the SDV 100 to a specified destination. The control system 120 can perform vehicle control actions (e.g., braking, steering, accelerating) and route planning using sensor information, as well as other inputs (e.g., transmissions from remote or local human operators, network communication from other vehicles, etc.).

In an example of FIG. 1, the control system 120 includes a computer or processing system which operates to process sensor data 111 received from a sensor system 102 of the SDV 100 that provides a sensor view of a road segment upon which the SDV 100 operates. The sensor data 111 can be used to determine actions which are to be performed by the SDV 100 in order for the SDV 100 to continue on a route to a destination. In some variations, the control system 120 can include other functionality, such as wireless communication capabilities using a communication interface 115, to send and/or receive wireless communications 117 over one or more networks 160 with one or more remote sources. In controlling the SDV 100, the control system 120 can issue commands 135 to control various electromechanical interfaces of the SDV 100. The commands 135 can serve to control the various control mechanisms 155 of the SDV 100, including the vehicle's acceleration system 152, steering system 154, braking system 156, and auxiliary systems 158 (e.g., lights and directional signals).

The SDV 100 can be equipped with multiple types of sensors 101, 103, 105 which can combine to provide a computerized perception of the space and the physical environment surrounding the SDV 100. Likewise, the control system 120 can operate within the SDV 100 to receive sensor data 111 from the collection of sensors 101, 103, 105 and to control the various control mechanisms 155 in order to autonomously operate the SDV 100. For example, the control system 120 can analyze the sensor data 111 to generate low level commands 135 executable by one or more controllers 140 that directly control the acceleration system 152, steering system 154, and braking system 156 of the SDV 100. Execution of the commands 135 by the controllers 140 can result in throttle inputs, braking inputs, and steering inputs that collectively cause the SDV 100 to operate along sequential road segments to a particular destination.

In more detail, the sensors 101, 103, 105 operate to collectively obtain a sensor view for the vehicle 100 (e.g., in a forward operational direction, or providing a 360 degree sensor view), and further to obtain situational information proximate to the SDV 100, including any potential hazards or obstacles. By way of example, the sensors 101, 103, 105 can include multiple sets of camera systems (video cameras, stereoscopic cameras or depth perception cameras, long range monocular cameras), remote detection sensors such as radar, LIDAR, and sonar, proximity sensors, infrared sensors, touch sensors, and the like. According to examples provided herein, the sensors can be arranged or grouped in a sensor system or array 102 (e.g., in a sensor pod mounted to the roof of the SDV 100) comprising any number of LIDAR, radar, monocular camera, stereoscopic camera, sonar, infrared, or other active or passive sensor systems.

Each of the sensors 101, 103, 105 can communicate with the control system 120 utilizing a corresponding sensor interface 110, 112, 114. Each of the sensor interfaces 110, 112, 114 can include, for example, hardware and/or other logical components which are coupled or otherwise provided with the respective sensor. For example, the sensors 101, 103, 105 can include a video camera and/or stereoscopic camera set which continually generates image data of the physical environment of the SDV 100. As an addition or alternative, the sensor interfaces 110, 112, 114 can include dedicated processing resources, such as provided with field programmable gate arrays (FPGAs) which can, for example, receive and/or preprocess raw image data from the camera sensor.

According to examples provided herein, the SDV control system 120 can implement a neural network 124 executing a machine learning model (e.g., a set of machine learning algorithms) to autonomously operate the control mechanisms 155 of the SDV 100. In some aspects, the control system 120 can receive a destination 119 either from an external entity over the network 160 (e.g., a backend route management system), or via input from a passenger of the SDV 100. The control system 120 can include a route planner 122 and a database 130 storing coarse road network maps 131, which the route planner 122 can utilize to determine a route 123 from a current location of the SDV 100 to the destination 119. In some aspects, the route planner 122 can also access third party network resources 165 over the one or more networks 160 to receive map data and/or traffic data to determine a most optimal route 123 to the destination 119.

In further implementations, the route planner 122 can update the route 123 dynamically as traffic conditions change while the SDV 100 is en route to the destination 119. As provided herein, the updates to the route 123 can cause the neural network 124 to adapt certain configurations that enable it to follow or track the updated route 123. Specifically, the neural network 124 can receive GPS data 127 from a GPS module 125 (or other type of satellite receiver) of the SDV 100, and establish one or more navigation points 129 on the route 123 affixed a certain distance or temporally ahead of the SDV 100. However, as described herein, examples are not limited to a single navigation point 129, but can comprise a pair, or any number of navigation points 129 set along the route 123 and in a forward operational direction of the SDV 100.

As provided herein, the navigation point(s) 129 can be established in global coordinates, whereas the destination 119 can be established in local coordinates. In other words, the navigation point(s) 129 can be set to be persistently ahead of the SDV 100 (e.g., fifty meters ahead), and can have coordinate values that continuously update in global coordinates as the SDV 100 progresses along the route 123. On the other hand, the neural network 124 can establish the destination 119 in local coordinates with respect to the traveling SDV 100. In accordance with examples, the neural network 124 can be trained to follow the navigation point(s) 129, which can act as a reference for the neural network 124 to make upcoming decisions, such as lane selections, acceleration and braking inputs in anticipation of a turn, and the turning actions themselves. In tracking the navigation point(s) 129, the neural network 124 is provided with a simple framework that enables the neural network 124 perform mid and high level operations on the control mechanisms 155 analogous to human decision-making to anticipate upcoming turns (e.g., lane selection, deceleration, and braking).

In variations, once the global coordinates of the SDV 100 are known from the GPS module 125, a local coordinate system may be established with the SDV's location as the origin point (e.g., in a local Cartesian x-y coordinate system). Thereafter, the navigation points 129 may be generated in this local coordinate system to be persistently ahead of the SDV 100 along the route 123. Thus, the neural network 124 can readily compare the coordinate values of the navigation points 129 in the local coordinate system of the SDV 100 (e.g., to determine an immediate route plan for an upcoming route segment). Additionally or alternatively, the neural network 124 can compare the coordinate values of the navigation points 129 with successive destinations set along the route 123 to identify route features, such as upcoming turns. Based on the comparisons between the coordinate values, the neural network 124 can modulate the acceleration, braking, and steering inputs accordingly.

It is contemplated that the navigation points 129 may be established to be persistently ahead of the SDV 100 along the current route, or may be selectively established ahead of the SDV 100 when the SDV 100 approaches various decision points along the route. For example, the navigation points 129 may be excluded when the route ahead of the SDV 100 provides only limited decision-making (e.g., a straight road with no intersections), which enables the neural network 124 to focus mainly on the sensor data 111 to identify any potential hazards and modulate steering, braking, and acceleration inputs based on observation of the SDV's situational surroundings. Upon approaching a decision point along the route—such as an intersection or road fork where the neural network 124 must decide on two or more directions—the navigation points 129 can be established, as described herein, to enable the neural network 124 to readily determine the immediate plan for the decision point (e.g., a turn action), and execute acceleration, braking, steering, and/or lane changing actions accordingly. The immediate plan can then be conveyed as control instructions (e.g., motion planning instructions) to steering, acceleration, and braking systems 152, 154, 156 of the SDV 100.

In some aspects, the one or more navigation points 129 may be triggered based on a predetermined distance or time prior to the SDV 100 approaching an intersection. For example, a road network map may be utilized to identify approach zones for decision areas (e.g., intersections), which can trigger the navigation points 129. In other implementations, the navigation points 129 may be triggered based on other parameters, such as a braking input by the neural network 124, a threshold speed being exceeded or crossed below, and the like.

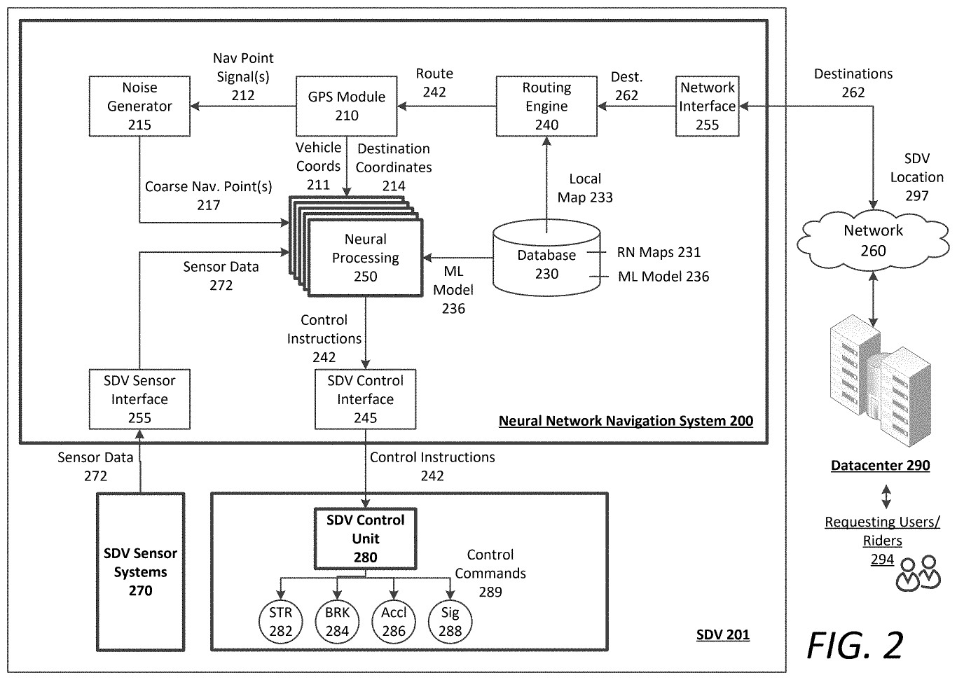

For lower level operations, the neural network 124 can analyze the sensor data 111 to detect other vehicles and any potential obstacles, hazards, or objects of interest (e.g., pedestrians or bicyclists). In variations, the neural network 124 can further analyze the sensor data 111 to detect traffic lanes, bike lanes, road signs, traffic signals, the current speed limit, and road markers (e.g., arrows painted on the road). In processing the sensor data 111, the neural network 124 does not require detailed localization maps or sub-maps of prerecorded and processed road segments along the route 123. Rather, in training and testing phases, the neural network 124 can implement machine learning to analyze the sensor data 111 to detect and identify objects of interest, ignore other objects, and operate the control mechanisms 155 of the SDV 100 to avoid any potential incidents. A more detailed discussion of the neural network 124 is provided below with respect to FIG. 2.

FIG. 2 is a block diagram illustrating an example neural network control system utilized in connection with a self-driving vehicle, according to examples described herein. In many aspects, the neural network control system 200 of the SDV 201 shown in FIG. 2 can perform one or more functions of the SDV control system 120 and neural network 124 as shown and described with respect to FIG. 1. As an example, the neural network control system 200 can comprise neural processing resources 250 that implement deep learning to train, adapt, and improve autonomous driving capabilities. In certain examples, the neural network control system 200 can include a network interface 255 that connects the neural network control system 200 to one or more networks 260. In some examples, the network interface 255 can communicate with one or more external devices over the network 260 to receive successive destinations 262.

In some implementations, the neural network control system 200 can communicate with a datacenter 290 hosting a backend transportation management system that deploys a fleet of SDVs throughout a given region (e.g., a metropolitan area) to provide application-based, on-demand transportation services, such as those provided by Uber Technologies, Inc. In such implementations, the datacenter 290 can receive driver and SDV locations throughout the given region, receive pick-up requests from requesting users 294, match those users with proximate available drivers or SDVs, and send invitations to those drivers and SDVs to service the pick-up requests. When the SDV 201 is selected to service a particular pick-up request, the datacenter 290 can transmit a destination 262 to the SDV 201, where the destination 262 corresponds to the pick-up location in which the SDV 201 is to rendezvous with the requesting user 294. Once the SDV 201 arrives at the pick-up location, the requesting user 294 or the datacenter 290 can provide the SDV 201 with a new destination 262—corresponding to a desired drop-off location for the user. Additionally or alternatively, the neural network control system 200 can receive the destination 262 locally from the passenger via an on-board interface, such as a display screen or a voice input interface (e.g., implementing speech recognition). Accordingly, the overall journey of the SDV 201 over the course of any given time frame can comprise a sequence of destinations 262 wherever a road network exists.

In any case, the destination 262 can be submitted to a routing engine 240 of the neural network control system 200. The routing engine 240 can access a database 230 storing road network maps 231, and can determine an optimal route 242 for the SDV 201 to travel from a current location to the destination 262. In certain implementations, the optimal route 242 can comprise a route that minimizes distance or time with regards to traffic conditions, speed limits, traffic signals, intersections, and the like. In some aspects, the neural network control system 200 can include a GPS module 210 (or other type of satellite receiver) that can establish one or more navigation point signals 212 for the SDV 201 at predetermined distances in a forward operational direction of the SDV 201 along the route. As described herein, the navigation points corresponding to the navigation point signals 212 can be established to be persistently ahead of the SDV 201 along the route 242, either distance-wise or temporally.

In some examples, the GPS module 210 can provide the neural processing resources 250 with GPS signals corresponding to the navigation points, which the neural processing resources 250 can project ahead of the SDV 200 as navigation points to follow along the route 242 to the destination 262. In such examples, the neural network processing resources 250 can establish the navigation point signals 212 in global coordinates, or coordinates with respect to an inertial frame of reference. Accordingly, as the SDV 201 travels throughout the given region, the coordinate values of the navigation points will vary with respect to the inertial reference frame. As such, the navigation points can be affixed to the SDV's 201 non-inertial reference frame at predetermined distances ahead of the SDV 201 along the route 242 (e.g., analogous to an L4 Lagrange point). In one example, the neural network control system 200 can establish the destination coordinates 214 in local coordinates, or as an address point, in the non-inertial reference frame of the SDV 100. Accordingly, the navigation point coordinates can be tracked by the neural processing resources 250 to the destination 262 by comparison of their coordinate values and/or the coordinate values of the vehicle 211.

In variations, the navigation points 212 can be established in a local coordinate system having an origin at the SDV's current location. Furthermore, the neural network processing resources 250 can readily compare the coordinate values of the navigation points 212 with the SDV's current location as the origin. Additionally or alternatively, the navigation points 212 can be computed based on the current location of the SDV 201 and the map route 242 of the SDV 201 from the current location to an overall destination.

In various implementations, the coordinates for the navigation points 212 can comprise two-dimensional coordinates that the neural processing resources 250 can continuously analyze in order to anticipate and execute turns, make lane selections, speed up or slow down, and otherwise vary the acceleration, braking, and steering inputs for the SDV 201. In certain aspects, each navigation point 212 comprises a Cartesian x-coordinate and y-coordinate, which provides a simple framework for the neural processing resources 250 to track and make control decisions in autonomously operating the SDV 201, as described in further detail below.

Examples provided herein recognize that neural networks can be trained to utilize and balance multiple inputs to achieve a desired outcome. In the case of the neural network control system 200, the neural processing resources 250 can execute a machine learning model 236 to utilize both the navigation point signals 212 and sensor data 272 from a number of sensor systems 270 of the SDV 201. As described herein, the SDV sensor systems 270 can comprise monocular and/or stereoscopic cameras. Additionally or alternatively, the SDV sensor systems 270 can include one or more LIDAR systems, radar systems, sonar systems, and/or proximity sensors that can generate the sensor data 272 to be analyzed by the neural processing resources 250 of the neural network control system 200. The sensor data 272 can be received via a SDV sensor interface 255, and can be submitted in raw form to the neural processing resources 250, or may be preprocessed by addition processing resources of the SDV 201 to eliminate non-essential data in order to reduce overall load on the neural processing resources 250.

Examples provided herein further recognize that with precise navigation point signals 212, the neural processing resources 250 may end up relying heavily on tracking the signals 212 without sufficient reliance on the sensor data 272. Thus, the neural network control system 200 can include noise generator 215 to introduce or otherwise incorporate noise (e.g., Gaussian distributed noise) into the navigation point signals 212 to generate coarse navigation points 217 for the neural processing resources 250 to track along the route 242. The introduced noise can result in larger horizontal error in the navigation point signals 212, and can cause the neural network processing resources 250 to desirably rely on the sensor data 272 in order to increase robustness of the system 200. Accordingly, based on the optimal route 242, the navigation point signals 212 can be run through a noise generator 215 to add noise, resulting in coarse navigation points 217. These coarse navigation points 217 can be received as inputs by the neural processing resources 250—along with the sensor data 272 and destination coordinates 214—to generate control instructions 242 to autonomously operate the control mechanisms of the SDV 200.

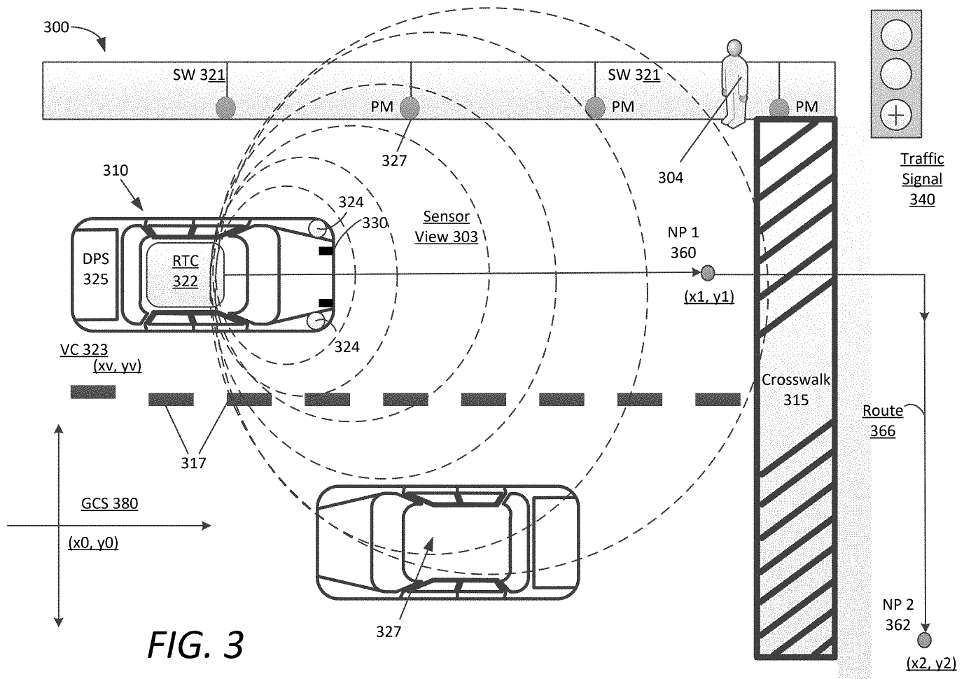

Accordingly, the neural processing resources 250 can extract the coarse navigation points 217 in global coordinates to localize along the optimal route 242 and continuously compute a future destination for the SDV 200. For example, the neural processing resources 250 can extract multiple coarse navigation points 217 at predetermined distances or temporally ahead of the SDV 201 along the optimal route 242 (e.g., based on the SDV's orientation and/or localization parameters), and continuously monitor the coordinate values of each of the coarse navigation points 217. In one aspect, the neural processing resources 250 compare the coordinate values of the coarse navigation points 217 to vehicle coordinates 211 of the SDV 201 to make mid or high level decisions with regard to an immediate route plan for an upcoming route segment. Additionally or alternatively, the neural processing resources 250 can correlate the coordinate values of the coarse navigation points 217, which can indicate, among other things, an upcoming turn. In one example, for Cartesian implementations, converging x-values between the navigation points 217 can indicate an upcoming or imminent turn, whereas the positive or negative aspect of the y-value can indicate the direction of the turn, as illustrated further in FIG. 3. For polar coordinate implementations, diverging angular values can indicate an upcoming turn and a turn direction. In any case, the neural processing resources 250 can utilize the coordinate values of the coarse navigation points 217 to adjust inputs for accelerating, braking, and steering the SDV 201.

The neural processing resources 250 can further receive, as additional input, the destination coordinates 214 as local coordinates in relation to the SDV 201. Additionally, each road segment for each immediate route plan can comprise one or more upcoming or immediate destinations in local coordinates of the SDV's local coordinate system (i.e., with the SDV's dynamic position as the origin). Each of these destinations can comprise fixed destination coordinates 214 in the SDV's local coordinate system. Accordingly, the neural processing resources 250 can utilize the destination coordinates 214 as successive targeted endpoints for each immediate route segment, or as an overall endpoint for the current trip. Thus, in operating the SDV's control mechanisms, the neural processing resources 250 can compare the navigation point coordinate values with the SDV's current coordinates and orientation (and additional vehicle parameters, such as speed, acceleration and braking inputs, etc.), and the successive destination coordinates 214. In executing the machine learning model 236, the neural processing resources 250 can be trained to balance processing between tracking the coarse navigation points 217 along the route 242 and analyzing the sensor data 272 for potential hazards. In doing so, the neural processing resources 250 can generate control instructions 242 executable by an SDV control unit 280 to operate the steering system 282, braking system 284, acceleration system 286, and the signaling and auxiliary systems 288 of the SDV 201. In examples, the control instructions 242 can determine a path, motion, or motion-relevant action of the SDV 201 over an upcoming path or portion of the planned route (e.g., over the next 5 seconds of travel by the SDV 201). In certain implementations, the neural network control system 200 can include a SDV control interface 245 through which the control instructions 242 are transmitted to the SDV control unit 280 for execution. The SDV control unit 280 can process the control instructions 242 to generate control commands 289 for direct implementation on the steering 282, braking 284, acceleration 286, and/or signaling systems 288 of the SDV 201.

The logical processes shown in connection with FIG. 2 are discussed in the context of logical blocks representing various elements and logic flows of the neural network control system 200. However, one or more of the foregoing processes may be performed by the backend datacenter 290, such as establishing the navigation points 217 based on the current location 297 of the SDV 201 and the optimal route 242, introducing noise to the navigation point signals 212, and determining the optimal route 242 for the SDV 201 to the destination 262. Thus, in the context of FIG. 2, the coarse navigation points 217 may be established by the datacenter 290 in global coordinates fixed to the SDV's 200 frame of reference, enabling the neural processing resources 250 to utilize basic road network maps 231 to extract and track the coarse navigation points 217 in order to autonomously operate the SDV 200 along the route 242. In doing so, the neural processing resources 250 may not only follow the route and perform lane-keeping, but may also make decisions concerning upcoming turns, such as lane selection, signaling, safety checks (e.g., analyzing the sensor data 272 for safe lane-changing and turning opportunities), and anticipatory braking and acceleration.

Self-Driving Vehicle in Operation

FIG. 3 shows an example of an autonomously controlled self-driving vehicle utilizing sensor data to navigate an environment in accordance with example implementations. In an example of FIG. 3, the autonomous vehicle 310 may include various sensors, such as a roof-top camera array (RTC) 322, forward-facing cameras 324 and laser rangefinders 330. In some aspects, a data processing system 325, comprising a combination of one or more processors, FPGAs, and/or memory units, can be positioned in the cargo space of the vehicle 310.

According to an example, the vehicle 310 uses one or more sensor views 303 (e.g., a stereoscopic or 3D image of the environment 300) to scan a road segment on which the vehicle 310 traverses. The vehicle 310 can process image data or sensor data, corresponding to the sensor views 303 from one or more sensors in order to detect objects that are, or may potentially be, in the path of the vehicle 310. In an example shown, the detected objects include a bicyclist, a pedestrian 304, and another vehicle 327—each of which may potentially cross into a road segment 315 along which the vehicle 310 traverses. The vehicle 310 can use information about the road segment and/or image data from the sensor views 303 to determine that the road segment includes a divider 317 and an opposite lane, as well as a sidewalk (SW) 321 and sidewalk structures such as parking meters (PM) 327.

The vehicle 310 may determine the location, size, and/or distance of objects in the environment 300 based on the sensor view 303. For example, the sensor views 303 may be 3D sensor images that combine sensor data from the roof-top camera array 322, front-facing cameras 324, and/or laser rangefinders 330. Accordingly, the vehicle may accurately detect the presence of objects in the environment 300, allowing the vehicle to safely navigate the route while avoiding collisions with other objects.

According to examples, the vehicle 310 may determine a probability that one or more objects in the environment 300 will interfere or collide with the vehicle 310 along the vehicle's current path or route. In some aspects, the vehicle 310 may selectively perform an avoidance action based on the probability of collision. The avoidance actions may include velocity adjustments, lane aversion, roadway aversion (e.g., change lanes or drive further from the curb), light or horn actions, and other actions. In some aspects, the avoidance action may run counter to certain driving conventions and/or rules (e.g., allowing the vehicle 310 to drive across center line to create space with bicyclist).

In variations, the vehicle 310 may implement a deep neural network through a series of training, test, and real-world implementation phases to ultimately build a robust skillset in autonomously operating the vehicle 310 on par with or exceeding human ratings or safety standards for autonomous driving. Thus, in analyzing the sensor view 303, the deep neural network can make on-the-fly assessments with regard to each detected object, and proactively control the autonomous vehicle 310 in accordance with certain safety standards (e.g., Safe Practices for Motor Vehicle Operations standards). In doing so, the deep neural network can seek to optimize autonomous driving habits in light of minimizing risk of collision (e.g., by identifying and anticipating potentially dangerous situations), implementing an assured clear distance ahead (e.g., a velocity-based following standard), and even practicing specific driving techniques geared towards efficiency and safety.

In an example, the data processing system 325 can implement the deep neural network (e.g., via execution of a set of machine learning algorithms) to identify static objects such as parking meters 327, and can accurately determine that the parking meters 327 are fixed objects (e.g., based on their relatively static or stable locations in the sensor views 303). The deep neural network can further detect and positively identify potential hazards, such as the bicyclist 302, pedestrian 304, and other vehicle 327. The deep neural network can further identify other objects in the sensor view 303 that may affect the manner in which the autonomous vehicle 310 travels along its given route 366, such as a crosswalk 315 and traffic signal 340. In performing lane-keeping, the deep neural network can identify the lane divider markers 317 and other road features indicating the bounds of the current lane being traveled (e.g., painted lines, curbs, parked cars, bike lanes, transition zones from concrete or asphalt to dirt or grass, and the like).

According to examples described herein, the deep neural network can extract one or more navigation points (e.g., navigation point 360 and navigation point 362) along the current route 366 of the vehicle 310. In some aspects, the navigation points 360, 362 can comprise two-dimensional Cartesian coordinate points established in global coordinates, and can be affixed as “carrot” points to the non-inertial reference frame of the vehicle 310. In the context of FIG. 3, the coordinate values of each navigation point 360, 362 can vary with respect to the global coordinate system 380 as the vehicle 310 travels along the current route 366. Thus, the deep neural network can track the navigation points 360, 362 along the route 366, dynamically compare the coordinate values of the navigation points 360, 362 with respect to each other (and/or the vehicle coordinates 323 of the SDV 310), and utilize the compared values to make decisions regarding the upcoming road segment of the SDV 310, such as lane selections and anticipatory actions (e.g., braking, signaling, checking individual portions of the sensor view, etc.).

In the example shown in FIG. 3, the global coordinate system 380 can comprise a mapping grid for a given area (e.g., based on an east/west and north/south grid, corresponding to the x and y axes respectively) that enables the deep neural network to determine upcoming characteristics of the route 366—such as road curves and turns—by following the navigation points 360, 362. In one aspect, the deep neural network can utilize the vehicle's own coordinates 323 to compare with one or more navigation points 360, 362 set in the forward direction of the vehicle. As such, converging x-values can correspond to an upcoming turn, and diverging y-values can correspond to the direction of the upcoming turn. The x-convergence and y-divergence (assuming current travel in an x direction) can enable the deep neural network to respond to by selecting an appropriate lane, signaling using the vehicle's directional signals, braking at the upcoming intersection or turn, and steering and accelerating to complete the turn.

The use of two-dimensional Cartesian coordinates is provided herein for illustration only, and is not meant to be limiting in any way. The navigation points 360, 362, the vehicle coordinates 323, and the destination coordinates may be in any two-dimensional or three-dimensional coordinate system or reference frame, and can utilize any combination of Cartesian global and local coordinates, two-dimensional polar global coordinates and local coordinates, and/or three-dimensional spherical global and/or local coordinates. Thus, the deep neural network implemented on the data processing system 325 can extract the coordinate values of the navigation points 360, 362 (in any set coordinate system)—as the vehicle 310 travels throughout a given region—for dynamic comparison in order to determine an immediate route plan (e.g., for the next hundred meters or the next thirty seconds of driving) and execute any number control actions on the vehicle 310 to implement the immediate route plan.

In conjunction with the route following discussion utilizing the navigation points 360, 362, the deep neural network can dynamically analyze the sensor view 303 for lower level safety concerns, such as potential hazard threats from other vehicles 327, local pedestrians 304 and bicyclists 302. The deep neural network may further process the sensor view 303 to identify road and traffic features—such as the traffic signal 340 and signal state (e.g., red, yellow, or green), crosswalk 315, sidewalk 321, and lane divider 317—in order to make lower level decisions with regards to actual execution of lane changes, braking for an upcoming intersection, and safely executing upcoming turns identified by the navigation points 360, 362.

Methodology

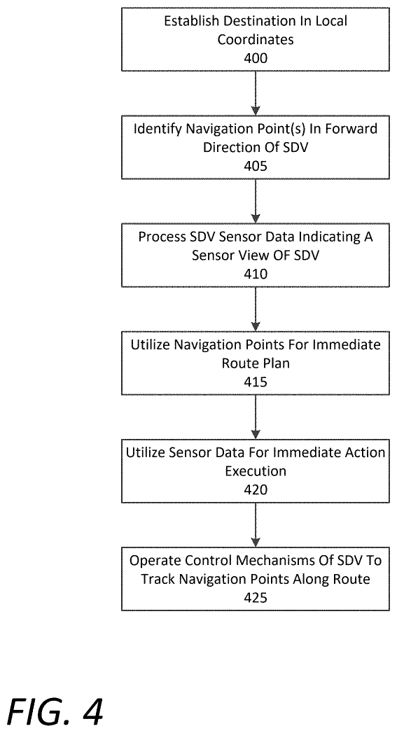

FIG. 4 is a flow chart describing an example method of autonomously operating a self-driving vehicle through use of a neural network, according to examples described herein. In the below description of FIG. 4, reference may be made to reference characters representing like features as shown and described with respect to FIGS. 1-3. Furthermore, the method described in connection with FIG. 4 may be performed by a neural network 124 or neural network control system 200 being implemented on a self-driving vehicle 100, 200, as shown and described herein. Referring to FIG. 4, the neural network 124 can establish a destination 119 in local coordinates (400). The neural network 124 can further identify one or more navigation points 129 in a forward operational direction of the SDV 100 (405). As provided herein, the navigation points 129 may be extracted and established at affixed distances (or temporally) ahead of the SDV 100 by a backend entity with knowledge of the destination 119 and optimal route 123. In variations, the navigation points 129 may be extracted and established by a separate module of the of the SDV 100, or the neural network 124 itself, once the optimal route 123 to the destination 119 is determined.

In operating the control mechanisms 155 of the SDV 100, The neural network 124 may also process sensor data 111 indicating a sensor view from a sensor array 102 of the SDV 100 (410). According to some aspects described herein, the neural network 124 can utilize the navigation points 129 dynamically for an immediate route plan (415). Accordingly, the neural network 124 can compare the individual coordinate values of the navigation points 129 with each other—and/or with the vehicle coordinates of the SDV 100—in order to determine the immediate route plan for the upcoming road segment. The immediate route plan can comprise a plan for the next fifty or one hundred meters—or a set time period (e.g., the next thirty seconds)—of the overall route 123 of the SDV 100, and can correlate directly with the location of the navigation points 129 ahead of the SDV 100. Thus, the immediate route plan can correspond to an upcoming turn in which the SDV 100 must signal, change lanes, and execute the turn.

In various implementations, the neural network 124 may utilize the sensor data 111 for immediate action execution (420). The immediate action execution can comprise generating the individual command inputs 135 executable by the individual control mechanisms 155 of the SDV 100, such as the SDV's acceleration 152, steering 154, braking 156, and auxiliary systems 158. While executing the immediate route plan determined via comparison of the navigation points 129 (and/or the vehicle's own coordinates), the neural network 124 can analyze the sensor data 111 to determine exactly when to change lanes, brake for an intersection or potential hazard, and accelerate and steer the SDV 100 when the situation is safe to complete the turn. Thus, the neural network 124 can autonomously operate the control mechanisms 155 of the SDV 100 to track the navigation points 129 along the given route 123 (425).

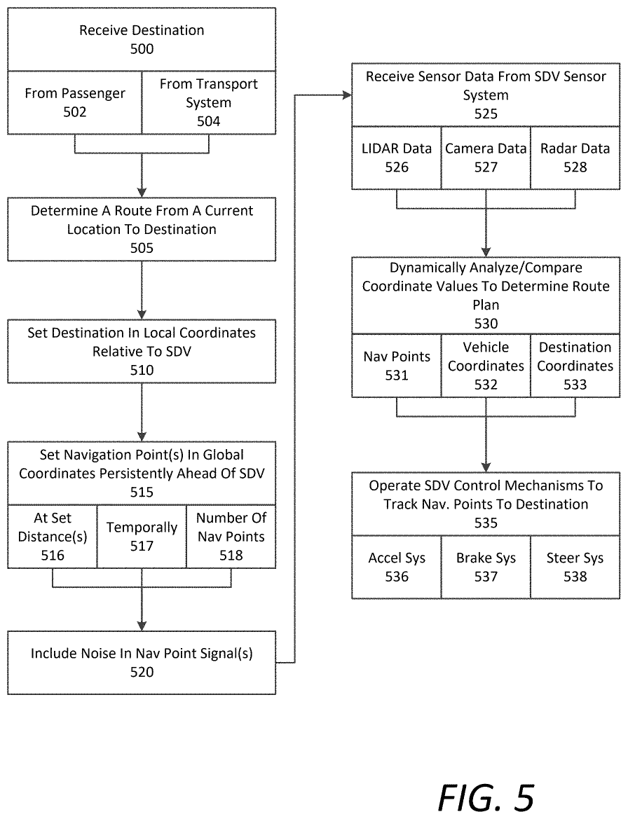

FIG. 5 is a lower level flow chart describing an example method of autonomously operating a self-driving vehicle through use of a neural network, according to examples described herein. In the below description of FIG. 5, reference may be made to reference characters representing like features as shown and described with respect to FIGS. 1-3. Furthermore, the method described in connection with FIG. 5 may be performed by a neural network 124 or neural network control system 200 being implemented on a self-driving vehicle 100, 200, as shown and described herein. Referring to FIG. 5, the neural network control system 200 can receive a destination 262 (500). The destination 262 can be received from a backend transportation management system implemented on a datacenter 290 (504), or can be inputted directly by a passenger of the SDV 201 through use of a local user interface (502).

In various implementations, the neural network control system 200 can determine a route 242 from a current location to the destination 262 (505), and set the destination 262 in local coordinates relative to the SDV 201 (510). The neural network control system 200 can further set one or more navigation points 212 in global coordinates, and affix or otherwise configure the navigation point(s) 212 to the non-inertial reference frame of the SDV 201 (515). In doing so, the neural network control system 200 can set the navigation points at persistent distances ahead of the SDV 201 along the route 242 (516), or temporally such that the navigation points 212 vary in distance from the SDV 201 (e.g., based on the SDV's current speed (517). For example, the temporal location for each of the navigation points 212 may be based on a computation of a time step (e.g., one or two seconds ahead of the SDV 201) and the SDV's current speed. In variations, the global coordinate values of the SDV 201 (e.g., via the GPS module 210) can be utilized to establish a local coordinate system with the SDV's current, dynamic location as the origin. In such variations, the navigation points 212, and successive upcoming destination coordinates 214, can be established in the SDV's local coordinate system along the route 242. As an example, a local Cartesian coordinate system (e.g., a two-dimensional x-y system) can be established with the positive x-axis extending in the forward operational direction of the SDV 201, and positive y-axis extending to the left of the SDV 201. The navigation point coordinates 212 and/or the successive destination coordinates 214 can be established with respect to this local Cartesian system, enabling the neural network processing resources 250 to readily identify, for example, an upcoming turn. In some aspects, the neural network control system 200 can set a combination of distance-based and temporally-based navigation points 212 to further increase robustness. Furthermore, the neural network control system 200 can set the number of navigation points (518), and can include a single point, or multiple points at various distances and/or times ahead of the SDV 201 along the route.

Additionally, the neural network control system 200 can include or otherwise introduce noise into the navigation point signals 212, such that the navigation points 212 comprise coarse navigation points 217 with a certain amount of increased horizontal error (520). As described herein, this can prevent the neural processing resources 250 of the neural network control system 200 to over-rely on the navigation points 217 in at least the training phase of the system 200, resulting in increased robustness of the system 200. In some aspects, the noise can be included in only the training and/or testing phases of the system 200. In such aspects, the noise can be excluded or reduced in the implementation phase. In variations, the noise may also be included during implementation of the system 200 on public roads. The neural network control system 250 can further receive sensor data 272 from the SDV sensor systems (525), which can include LIDAR data (526), camera or image data (527), and/or radar data (528). It is contemplated that the neural network control system 250 can be agnostic to the type of sensor data sources, and can utilize data from any individual sensor system (e.g., a single monocular, forward-facing camera), or combinations of sensor systems described herein.

In various implementations, the neural network control system 200 can dynamically analyze and compare coordinate values to continuously or periodically (e.g., every few seconds) determine an immediate route plan (530). As discussed above, the neural network control system 200 can compare various combinations of individual coordinate values of the coarse navigation points 217 (531), the vehicle coordinates of the SDV 201 (532), and the destination coordinates 214 (533). In certain implementations, the neural processing resources can determine a heading of the SDV 201, and utilize the heading to make comparisons between the coordinate values to ultimately determine the immediate route plan. Based on each of the immediate route plans, the neural network control system 200 can operate the SDV control mechanisms in order to track the coarse navigation points 217 to the destination 262 (535). Accordingly, the neural network control system 200 can operate the acceleration system 286 (536), the braking system 284 (537), and the steering system 282 (538) of the SDV 201 in order to perform the low level autonomous actions that progress the SDV 201 along each immediate route plan along the overall route 242 to the destination 262.

Multimodal Control System for SDV

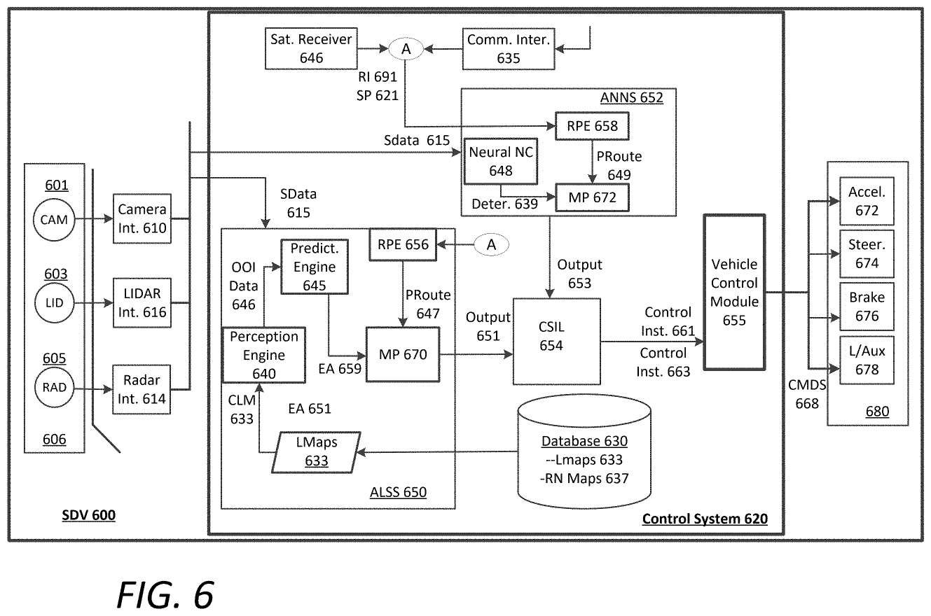

FIG. 6 is a block diagram illustrating an example of a multimodal autonomous control system for an SDV. In an example of FIG. 6, a control system 620 can autonomously operate an SDV 600 in a given geographic region for a variety of purposes, including transport services (e.g., transport of humans, delivery services, etc.), and without the use of human control. For example, the SDV 600 can autonomously steer, accelerate, shift, brake, and operate lighting components. In examples such as shown with FIG. 6, the control system 620 is multimodal to enable one of at least two separate autonomous control sub-systems to control the SDV 600. Specifically, the control system 620 can be alternatively implemented by two or more autonomous control sub-systems, including an autonomous localization sub-system (“ALSS”) 650 and an autonomous neural network sub-system (“ANNS”) 652. The control system 620 can implement each of (i) an autonomous localization mode, in which an output 651 of the ALSS 650 is used to control operation of the SDV 600, and (ii) an autonomous neural network mode that utilizes an output 653 of the ANNS 652 to control the operation of the SDV 600.

In examples, the control system 620 includes control system interface logic (“CSIL”) 654, which can include logic to select between either of the autonomous control sub-systems 650, 652 while the vehicle is on a trip. The CSIL 654 can use an output 651, 653 of the ALSS or ANNS 650, 652, to generate or otherwise provide corresponding control instructions 661, 663 for a vehicle control module 655 during an ensuing interval. In turn, the vehicle control module 655 can generate commands 668 to control the operation of various vehicle control systems of the SDV 600, including acceleration system 672, steering system 674, braking system 676, and lighting and auxiliary systems 678 (e.g., directional signals and headlights).

According to some examples, the control system 620 can utilize specific sensor resources to autonomously operate the SDV 600 in a variety of driving environments and conditions. For example, the control system 620 can operate the SDV 600 by autonomously operating the acceleration, steering, and braking systems 672, 674, 676 of the SDV 600 to a specified destination. The control system 620 can perform vehicle control actions (e.g., braking, steering, accelerating) and route planning using sensor information, as well as other inputs (e.g., transmissions from remote or local human operators, network communication from other vehicles, etc.).

In an example of FIG. 6, each of the ALSS 650 and ANNS 652 can include computational resources (e.g., processing cores and/or field programmable gate arrays (FPGAs)) which operate to process sensor data 615 received from a sensor system 606 of the SDV 600. In this way, each of ALSS and ANNS 650, 652 can receive a live sensor view of the vehicle's environment continuously, while the SDV operates. Each of ALSS and ANNS 650, 652 can also receive route instructions 691 from, for example, an external source (e.g., from a network service, via the communication interface 635). The route instructions 691 may specify, for example, a pickup location or destination for a passenger. In examples, each of ALSS and ANNS 650, 652 utilize corresponding route planning engines 656, 658 to determine a respective planned route 647, 649 for the SDV 600. Alternatively, the route planning engines 656, 658 can be implemented as a shared component or resource for the control sub-systems of the SDV 600.

In examples, each of ALSS and ANNS 650, 652 can also implement motion planning actions using the sensor data 615 and the planned routes 647, 649. (e.g., planning vehicle motion for segments of a route). The motion planning actions can correspond to actions that can be performed by the SDV in furtherance of the operation of the vehicle, using, for example, acceleration system 672, steering system 674, braking system 676, and/or lighting and auxiliary systems 678. In examples, the respective route planning engines 656, 658 can generate route segments as an input for a respective motion planning component 670, 672 of a corresponding control sub-system. Further, as described below, each of ALSS and ANNS 650, 652 can use sensor input 615 to implement motion planning actions on the part of the SDV as a response to detected events, while the vehicle is in operation. The motion planning actions of each autonomous control sub-system 650, 652 can be conveyed as, for example, a set of control instructions 661, 663, which can be outputted directly to the vehicle control module 655. The motion planning actions of each autonomous control sub-system 650, 652 can alternatively be communicated to the CSIL 654 as respective output 651, 653, and the CSIL 654 can then generate or provide control instructions 661, 663 to the vehicle control module 655 based on the respective outputs 651, 653.

In examples, the CSIL 654 can process output 651, 653 (e.g., instructions) that are received from each of the respective ALSS 650 and ANNS 652. The CSIL 654 selects one of the autonomous localization or neural network modes as the control authority for the vehicle control module 655. As described in greater detail, the CSIL 654 can select modes seamlessly, so that the control authority for vehicle control module 655 can change without any noticeable interruption of the SDV 600. Thus, for example, the SDV 600 can start and finish a trip along a route, where the particular autonomous mode (and corresponding autonomous control sub-system) changes one or multiple times. In some variations, the control system 620 can include other functionality, such as wireless communication capabilities using a communication interface 635, to send and/or receive wireless communications over one or more networks with a remote source. In controlling the SDV 600, the control system 620 can generate commands 668 to control the various control mechanisms 680 of the SDV 600, including the vehicle's acceleration system 672, steering system 674, braking system 676, and auxiliary systems 678 (e.g., lights and directional signals).

The SDV 600 can be equipped with a sensor suite 606, which can include multiple types of sensors that can combine to provide a computerized perception, or sensor view, of the space and the physical environment surrounding the SDV 600. Likewise, each of the ALSS and ANNS 650, 652 can operate within the SDV 600 to receive sensor data 615 from the sensor suite 606 and to control the various control mechanisms 680 in order to autonomously operate the SDV 600. For example, each of the ALSS and ANNS 650, 652 can analyze the sensor data 615 to generate low level commands 668 executable by the acceleration system 672, steering system 674, and braking system 676 of the SDV 600. Execution of the commands 668 by the control mechanisms 680 can result in throttle inputs, braking inputs, and steering inputs that collectively cause the SDV 600 to operate along sequential road segments according to a given route.

In more detail, the sensor suite 606 operates to collectively obtain a live sensor view for the SDV 600 (e.g., in a forward operational direction, or providing a 360 degree sensor view), and to further obtain situational information proximate to the SDV 600, including any potential hazards or obstacles. By way of example, the sensors 606 can include multiple sets of camera systems 601 (video cameras, stereoscopic cameras or depth perception cameras, long range monocular cameras), LIDAR systems 603, one or more radar systems 605, and various other sensor resources such as sonar, proximity sensors, infrared sensors, and the like. According to examples provided herein, the sensors 606 can be arranged or grouped in a sensor system or array (e.g., in a sensor pod mounted to the roof of the SDV 600) comprising any number of LIDAR, radar, monocular camera, stereoscopic camera, sonar, infrared, or other active or passive sensor systems.

The sensor suite 606 can communicate with each of the control sub-systems 650, 652 utilizing a corresponding sensor interface 610, 616, 614. Each of the sensor interfaces 610, 616, 614 can include, for example, hardware and/or other logical components which are coupled or otherwise provided with the respective sensor. For example, the sensor suite 606 can include a video camera and/or stereoscopic camera system 601 which continually generates image data of the physical environment of the SDV 600. The camera system 601 can provide the image data for the control system 620 via a camera system interface 610. Likewise, the LIDAR system 603 can provide LIDAR data to the control system 620 via a LIDAR system interface 616. Furthermore, as provided herein, radar data from the radar system 605 of the SDV 600 can be provided to the control system 620 via a radar system interface 614. In some examples, the sensor interfaces 610, 616, 614 can include dedicated processing resources, such as provided with field programmable gate arrays (FPGAs) which can, for example, receive and/or preprocess raw sensor data for use with each of the ALSS and ANNS control sub-systems 650, 652. By way of example, the camera system interface 610 and/or Lidar system interface 616 can utilize one or more FPGAs (or other types of processing resources) to preprocess image and/or LIDAR data from the respective sensors of the camera system 601 and/or Lidar system 603, for use with the ALSS and ANNS control sub-systems 650, 652. The preprocessing of the image and/or LIDAR data can include, for example, performing normalization, segmentation and/or object detection, using either individual data frames or sets of multiple data frames, with each data frame including image and/or LIDAR data from a corresponding camera system 601 and/or LIDAR system 603.

In examples, the ALSS 650 includes a perception engine 640, a prediction engine 645 and the motion planning component 670. When operated in the autonomous localization mode, the sensor suite 606 collectively provide sensor data 615 to the perception engine 640, and the perception engine 640 operates by accessing one or more localization maps 633 from a database 630 or other memory resource of the SDV 600. The localization maps 633 that are stored with the SDV 600 can define an autonomy grid map, which identifies boundaries between where the localization maps are reliable (e.g., updated) or available. The localization maps 633 can comprise a series of road segment sub-maps corresponding to an autonomy grid map, as described with some examples. In an aspect, the localization maps 633 include highly detailed ground truth data of each road segment of the given region. For example, the localization maps 633 can included prerecorded data (e.g., sensor data including image data, LIDAR data, and the like) obtained by specialized mapping vehicles or other SDVs with recording sensors and equipment, and the localization maps 633 can be processed to pinpoint various objects of interest (e.g., traffic signals, road signs, and other static objects). As the SDV 600 travels along a given route, the perception engine 640 can access a current localization map 633 of a current road segment to compare the details of the current localization map 633 with the sensor data 615. Among other functions, the comparison can be performed to detect and classify objects of interest, such as moving vehicles, pedestrians, and/or other moving objects.

In various examples, the perception engine 640 can dynamically compare the live sensor data 615 from the SDV's sensor systems 606 to the current localization map 633 as the SDV 600 travels through a corresponding road segment. When the SDV operates, the perception engine 640 can flag or otherwise identify any objects of interest in the live sensor data 615 that can indicate a potential hazard.

In examples, the perception engine 640 can provide object of interest data 643 to a prediction engine 645 of the control system 620, wherein the objects of interest in the object of interest data 643 indicates each classified object that can comprise a potential hazard (e.g., a pedestrian, vehicle, unknown object, etc.). Based on the classification of the objects in the object of interest data 643, the prediction engine 645 can predict a path of each object of interest and determine whether the SDV 600 should respond or react accordingly. For example, the prediction engine 640 can dynamically calculate a collision probability for each object of interest, to generate event alerts 659 if the collision probability exceeds a certain threshold. As described herein, such event alerts 659 can be processed by the motion planning component 670, along with a processed sensor view that indicates one or more classifications about the object within the live sensor view of the SDV 600. In an example, the motion planning component 670 can determine an action to change a position, speed, and/or trajectory of the SDV 600 as it travels forward. In variations, the motion planning component 670 can determine a candidate set of alternate actions, of which at least some can change the position, speed and/or trajectory of the SDV 600. In such variations, the motion planning component 670 can implement a monitoring process to implement one or more selected actions, from the candidate set of possible actions, based on updated information provided by the prediction engine 645 and/or perception engine 640.

In examples, the ANNS 652 can include a neural network component 648 that includes neural network processing resources, such as described with examples of FIG. 1 and FIG. 2. For example, the neural network component 648 can be implemented in accordance with neural network control system 200 (see FIG. 2) to train and utilize machine learning models for operating the SDV 600. The neural network component 648 can process the sensor information 615 to make determinations 639 about immediate events, and such as determinations as to whether the SDV 600 should change trajectory, speed or position (e.g., lane) in response to an event or condition detected from the sensor information 615. The determinations 639 can be communicated by the motion planning component 672 as output 653 (e.g., instructions), for the CSIL 654. In examples, the ANNS 652 can generate the output 653 (e.g., instructions) without use of localization maps or sub-maps of prerecorded or processed road segments of a respective route. Rather, the ANNS 652 can utilize inputs corresponding to the current location 621 and/or road network maps 637, which may be stored with the database 630 and/or received from an external source, such as through communication interface 635. The ANNS 652 can utilize the input to generate the respective output 653.

In examples, the control system 620 implements one of the autonomous control modes at a given moment. In some examples, the CSIL 654 determines which of the autonomous control modes are implemented at any portion of a given trip, where the determination can be based on, for example, a current location of the SDV 600 with respect to a boundary of an autonomous grid map. Still further, in such examples, the CSIL 654 receives the current location 621 from satellite receiver 646 (e.g., GPS component), and the CSIL 654 compares the current location of the SDV 600 with the boundaries of the autonomous grid map. If the SDV 600 is within the region of the autonomous grid map, the CSIL 654 may select (or continue to select) the autonomous localization mode, where the output 651 of the ALSS 650 is used to generate control instructions 661 for the vehicle control module 655. If the SDV 600 is outside of the autonomous grid map, the CSIL 654 may select (or continue to select) the autonomous neural network mode, where the output 653 of the ANNS 652 is used to generate control instructions 663 for the vehicle control module 655. In such examples, the determination of which autonomous mode should control the SDV 600 can be made by the CSIL 654, based on the current location of the SDV 600 and the boundaries of the autonomous grid map. As an addition or variation, the CSIL 654 may also use a planned route of the SDV 600 to determine when the SDV 600 should operate in the autonomous localization mode (using the localization maps 633) versus the autonomous neural network mode (without using the localization maps 633).

In examples provided above, the determination to implement the autonomous neural network mode can be in response to a determination that the autonomous grid map is not reliable, up to date, or otherwise available at the current or planned location of the SDV 600. In variations, the determination to implement the autonomous neural network mode can be based on a determination that the autonomous neural network mode is more reliable than the autonomous localization mode. Such a determination can be made when, for example, the machine learning of the neural network component 648 are highly trained, given a particular location or condition (e.g., environmental condition like rain or snow) of the SDV 600. Still further, the determination to implement any one of the multiple possible modes may be based on a confidence value that the ALSS 650 and/or ANNS 652 associate with their respective outputs 651, 653.

Still further, the CSIL 654 can select one of the alternative autonomous modes by repeatedly comparing the outputs 651, 653 of each of the control sub-systems 650, 652. The CSIL 654 can separately analyze the outputs 651, 653 to determine if the output of the selected control sub-system has a low confidence value, or to determine whether the output is inaccurate in view of the output of the other control sub-system.

The CSIL 654 can seamlessly transition between the alternate autonomous modes. In some examples, the ALSS and ANNS 650, 652 can operate concurrently and independently while the SDV 600 is on a trip, so that each of the control sub-systems continuously or repeatedly generates respective outputs 651, 653. To implement one of multiple possible modes, the CSIL 654 can, during a given time interval, accept the output 651, 653 of either the ALSS 650 or ANNS 652, based on inputs such as the current location and/or the availability of the autonomous grid map, as described above. When the CSIL 654 determines to switch modes, the CSIL 654 can discard the output 651, 653 of whichever of the ALSS 650 or ANNS 652 it had just previously accepted, while discarding the output 651, 653 from the other of the ALSS 650 or ANNS 652 it had just previously discarded. In each case, the CSIL 654 can generate the control instructions 661, 663 based on the respective output 651, 653 of whichever autonomous control system is selected at that time.

While in some examples, the ALSS and ANNS 650, 652 operate independently, in variations, (i) the ALSS 650 can receive and utilize the output 653 of the ANNS 652 as input, and/or (ii) the ANNS 652 can receive and utilize the output 651 of the ALSS 650 as input. For example, the ALSS 650 can record a situation when a confidence level of its output 651 is below a threshold level. In such instances, the ALSS 650 can receive and record the output 653 of the ANNS 652 for the corresponding time interval as an outcome of the situation. The ALSS 650 can use the output 653 of the ANNS 652 to train one or more of its models for specific aspects of the situation which caused the output 651 to have a low confidence value, so that the ALSS 650 can more intelligently (and confidently) generate a suitable output 651 for handling a similar situation on a next occurrence.

To illustrate, the SDV 600 may approach an intersection that normally has a traffic light, but at the time of the SDV's approach, the traffic light is missing (e.g., light falls from pole because of high wind). In the illustration, the ALSS 650 may generate a low confidence outcome 651 because its model is trained to detect the lights, or at least the housing of the traffic light, but ALSS 650 may not be trained for the complete absence of the light, particularly when the relevant localization map provides that a traffic light should be present. In such a scenario, the outputs 651 of the ALSS 650 as it approaches the intersection may have low confidence, such that, absent intervention, the SDV 600 would operate with an inordinate amount of caution. In contrast, the ANNS 652 may have a lesser expectation of the traffic light being present, as it does not use the localization map. Rather, the ANNS 652 may, as it approaches the intersection, recognize a general pattern of vehicles ahead of the SDV stopping and then going through the intersection, and the ANNS 652 may simply observe that there is no traffic light. Based on what the ANNS 652 observes with respect to vehicles in front, and in absence of a traffic light, the ANNS 652 may generate the output 653 with a relatively high confidence value, to have the SDV 600 operate the intersection as a stop-and-go intersection. In such a scenario, the CSIL 654 may select the output 653 of the ANNS 652 over the output 651 of the ALSS 650. At the same time, the output 653 of the ANNS 652 over an interval in which the SDV is approaching the intersection (e.g., SDV approaching the intersection as a stop-and-go intersection) can be provided to the ALSS 650, which in turn can utilize the output 653 as an outcome from which one or more models of the ALSS 650 can be trained. For example, the ALSS 650 can be trained, using the output 653, to generate a more suitable output 651 (e.g., a less-cautious approach by the SDV to the intersection) for encountering a missing traffic light (e.g., when no traffic light is detected, based on a detected traffic pattern at the intersection).

As an addition or variation, the ALSS 650 can also query for, or otherwise receive the output 653 of the ANSS 652, to use as input for making on-the-fly determinations. In an example, when the output 651 of the ALSS 650 is below a threshold, the ALSS 650 can use the output 653 of the ANNS 652 as input, to determine if its own output 651 can improve using information indicated by the output 653 of the ANNS 652. Likewise, the ALSS 650 can use the output 653 of the ANNS 652 to update its localization map. For example, the ALSS 650 can infer from the output 653 of the ANNS 652 that a stop-and-go situation exists at a particular intersection, and the ALSS 650 can update its localization map to reflect the condition. In turn, the localization map of other SDVs may also be updated.

Similarly, in some variations, the ANNS 652 can receive and use the output 651 of the ALSS 650 as input for training or other purposes. For example, the SDV may encounter sharp objects that fall off of a flatbed on a road segment. As the SDV approaches the sharp objects, the ANNS 652 may recognize the objects as being small, but not sharp. As the ANNS 652 may not have a full recognition of what the sharp objects may be, the output 653 of the ANNS 652 may reflect low confidence. The ALSS 650, on the other hand, may have the objects labeled (e.g., “tire hazard” for nails and screws) on its localization map (e.g., through manual input and/or other vehicles which may update the localization map), and its output 651 (e.g., slow down and change lanes) may reflect the nature of the objects on the road. The ANNS 652 may receive the output 651 of the ALSS 650, and models used by the ANNS 652 may be trained to learn to match the sensor view of the small objects with the output of an avoidance action (e.g., change lanes).

As an addition or variation, the ANNS 652 may use the output 651 of the ALSS 650 as input to make a determination for its own output 653, on-the-fly, with respect to a road condition or event. To use the illustration of the nails and screws on the road, the ANNS 652 can detect small objects of unknown nature. The ANNS 652 may query for, or otherwise receive the output 651 of the ALSS 650. If the output of the ALSS 650 indicates awareness of the potential hazard, as well as a relatively high confidence with respect to how the SDV should handle the potential hazard, the ANNS 652 may infer characteristics relating to the nature of the objects based on the output 651 of the ALSS 650. For example, if the output 651 of the ALSS 650 is to slow-down and change lanes, or swerve to avoid the location of the hazard, the ANNS 652 may assume the object is hazardous, at least to the tires of the vehicle, and the output 653 of the ANNS 652 may correspond to a similar set of driving actions.

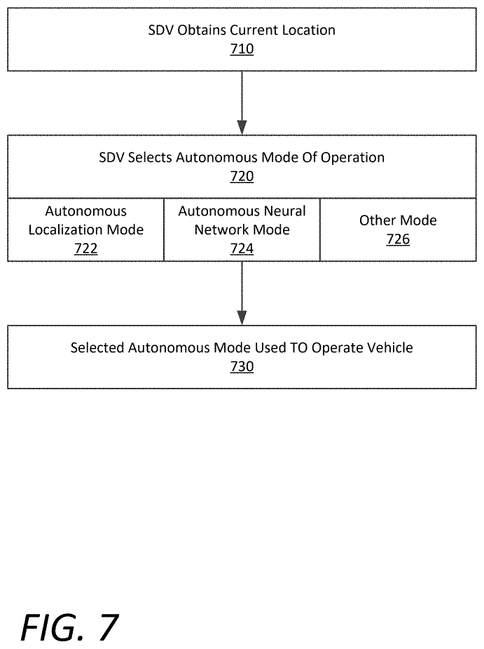

FIG. 7 illustrates a method for operating an SDV using a multimodal control system. An example of FIG. 7 may be implemented using, for example, a control system or SDV such as described with examples of FIG. 6. Accordingly, reference may be made to elements of FIG. 6 or FIG. 7 for purpose of illustrating suitable components for performing a step or sub-step, as described.

With reference to an example of FIG. 7, SDV 600 can operate to receive its current location (710). The SDV 600 can, for example, repeatedly receive its current location from the satellite receiver 646.

Based on factors such as current location of the SDV 600, the control system 620 of the SDV can select one of at least two alternative modes for operating the SDV (720). As described with some examples, the control system 620 of the SDV can implement each of an autonomous localization mode (722) and an autonomous neural network mode (724). In the autonomous localization mode, the control system 620 uses instructions that are generated by, or based on an output of the ALSS 650. As described with examples of FIG. 6, the ALSS 650 implements the autonomous localization mode using the localization maps 633, along with localization processes that are based on, or otherwise utilize the localization maps 633, such as represented by perception engine 640, prediction engine 645, and motion planning component 670. In contrast, the ANNS 652 implements the autonomous neural network mode using machine learning models, and without the use of localization maps 633.

In some variations, the control system 620 can select another mode of operating the SDV 600 (726), based on factors such as the current location of the SDV 600. By way of example, the control system 600 can select to switch the operating mode of the SDV to one that is manual (e.g., safety driver), or one that is partially manual, such as a driving mode that utilizes a lower level of autonomous operation in combination with a human operator that is either present in the vehicle or remote from the vehicle.

The SDV 600 can autonomously travel along a planned route, or portion thereof, using the selected one of the autonomous localization mode or the autonomous neural network mode (730). As described by various examples, the control system 620 can select the autonomous mode while the SDV is traveling on a route. Additionally, the factors in making the determination include, for example, one or more of the current location of the SDV, the planned route or a planned location of the SDV, the confidence of reliability of the respective control sub-system for each mode, and environmental or other conditions which may make one mode more suitable than the other.

Hardware Diagrams

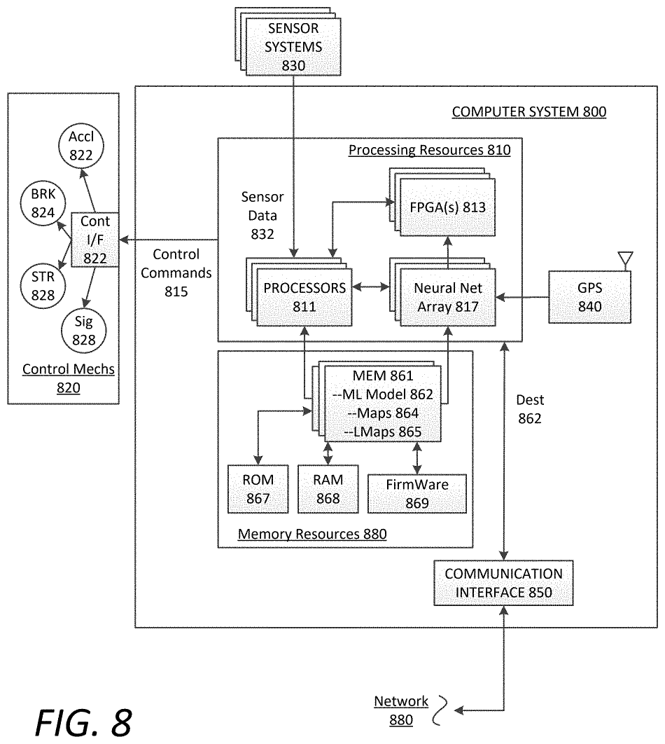

FIG. 8 is a block diagram illustrating a computer system upon which example SDV processing systems described herein may be implemented. The computer system 800 can be implemented using a number of processing resources 810, which can comprise processors 811, field programmable gate arrays (FPGAs) 813. Furthermore, any number of processors 811 and/or FPGAs 813 of the computer system 800 can be utilized as components of a neural network array 817 implementing a machine learning model 862 and utilizing road network maps 864 stored in memory 861 of the computer system 800. In the context of FIGS. 1, 2 and 6, the control system 120, neural network 124, neural network control system 200 and control system 620, respectively, can be implemented using one or more components of the computer system 800 shown in FIG. 8.

According to some examples, the computer system 800 may be implemented within an autonomous vehicle or self-driving vehicle (SDV) with software and hardware resources such as described with examples of FIGS. 1 and 2. In an example shown, the computer system 800 can be distributed spatially into various regions of the SDV, with various aspects integrated with other components of the SDV itself. For example, the processing resources 810 and/or memory resources 860 can be provided in a cargo space of the SDV. The various processing resources 810 of the computer system 800 can also execute control instructions and the machine learning model 862 (e.g., comprising a set of machine learning algorithms) using microprocessors 811, FPGAs 813, or any combination of the same. In some examples, the machine learning model 862 can be executed by various combinations of processors 811 and/or FPGAs 813 that make up the neural network array 817. Along these lines, various executable tasks embedded in the machine learning model 862 may be distributed amongst the multiple types of processing resources 810 of the computer system 800 that make up the neural network array 817.

In an example of FIG. 8, the computer system 800 can include a communication interface 850 that can enable communications over a network 880. In one implementation, the communication interface 850 can also provide a data bus or other local links to electro-mechanical interfaces of the vehicle, such as wireless or wired links to and from control mechanisms 820 (e.g., via a control interface 822), sensor systems 830, and can further provide a network link to a backend transport management system (implemented on one or more datacenters) over one or more networks 880. For example, the processing resources 810 can receive a destination 882 over the one or more networks 880, or via a local user interface of the SDV.

The memory resources 860 can include, for example, main memory 861, a read-only memory (ROM) 867, storage device, and cache resources. The main memory 861 of memory resources 860 can include random access memory (RAM) 868 or other dynamic storage device, for storing information and instructions which are executable by the processing resources 810 of the computer system 800. The processing resources 810 can execute instructions for processing information stored with the main memory 861 of the memory resources 860. The main memory 861 can also store temporary variables or other intermediate information which can be used during execution of instructions by the processing resources 810. The memory resources 860 can also include ROM 867 or other static storage device for storing static information and instructions for the processing resources 810. The memory resources 860 can also include other forms of memory devices and components, such as a magnetic disk or optical disk, for purpose of storing information and instructions for use by the processing resources 810. The computer system 800 can further be implemented using any combination of volatile and/or non-volatile memory, such as flash memory, PROM, EPROM, EEPROM (e.g., storing firmware 669), DRAM, cache resources, hard disk drives, and/or solid state drives.

According to some examples, the memory 861 may store a set of software instructions and/or machine learning algorithms including, for example, the machine learning models 862. The memory 861 may also store road network maps 864 in which the processing resources 810—executing the machine learning model 862—can utilize to extract and follow navigation points (e.g., via location-based signals from a GPS module 640), introduce noise to the navigation point signals, determine successive route plans, and execute control actions on the SDV. The machine learning model 862 may be executed by the neural network array 817 in order to autonomously operate the SDV's acceleration 822, braking 824, steering 826, and signaling systems 828 (collectively, the control mechanisms 820). Thus, in executing the machine learning model 862, the neural network array 817 can make mid or high level decisions with regard to upcoming route segments, and the processing resources 810 can receive sensor data 632 from the sensor systems 830 to enable the neural network array 817 to dynamically generate low level control commands 815 for operative control over the acceleration, steering, and braking of the SDV. The neural network array 317 may then transmit the control commands 815 to one or more control interfaces 822 of the control mechanisms 820 to autonomously operate the SDV through road traffic on roads and highways, as described throughout the present disclosure.

The memory 861 may also store localization maps 865 in which the processing resources 810—executing the control instructions 862—continuously compare to sensor data 832 from the various sensor systems 830 of the SDV. Execution of the control instructions 762 can cause the processing resources 810 to generate control commands 815 in order to autonomously operate the AV's acceleration 822, braking 824, steering 826, and signaling systems 828 (collectively, the control mechanisms 820). Thus, in executing the control instructions 862, the processing resources 810 can receive sensor data 832 from the sensor systems 830, dynamically compare the sensor data 832 to a current localization map 865, and generate control commands 815 for operative control over the acceleration, steering, and braking of the SDV along a particular route. As described by various examples, the computer system 800 can enable alternative autonomous modes—including a first mode to utilize the neural network array 817, and a second mode to utilize the localization maps 865.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A control system for a self-driving vehicle (“SDV”), the control system comprising:
a plurality of processing resources; and
memory resources to store processing instructions and a set of localization maps;
wherein the plurality of processing resources execute the processing instructions to implement one of at least two modes for operating the SDV, the processing instructions including (i) a first set of processing instructions that are executable by at least a first processing resource of the plurality resources to implement a first mode in which the SDV is controlled using the set of localization maps, and (ii) a second set of processing instructions that are executable by at least a second processing resource to implement a second mode in which the SDV is controlled using a neural network component.

2. The control system of claim 1, wherein the first processing resource is operable as part of a first control sub-system, and wherein the second processing resource is operable as part of a second control sub-system, and wherein the first control sub-system is independent of the second control sub-system.

3. The control system of claim 1, wherein the plurality of processing resources execute the processing instructions to select one of the at least two modes to operate the SDV based on a current location of the SDV.

4. The control system of claim 1, wherein the plurality of processing resources execute the processing instructions to select one of the at least two modes to operate the SDV based on at least a portion of a planned route or location for the SDV.

5. The control system of claim 1, wherein the plurality of processing resources execute the processing instructions to select one of the at least two modes to operate the SDV based on at least one of a pickup or destination location for a passenger of the SDV.

6. The control system of claim 1, wherein the plurality of processing resources execute the processing instructions to repeatedly receive an output from each of the first processing resource executing the first set of processing instructions and the second processing resource executing the second set of processing instructions.

7. The control system of claim 6, wherein the plurality of processing resources implement the first mode by discarding an output of the second processing resource executing the second set of processing instructions, while using an output of the first processing resource executing the first set of processing instructions to generate a first set of control instructions for operating the SDV.

8. The control system of claim 7, wherein the plurality of processing resources implement the second mode by discarding the output of the first processing resource executing the first set of processing instructions, while using the output of the second processing resource executing the second set of processing instructions to generate a second set of control instructions for operating the SDV.

9. The control system of claim 8, wherein the plurality of processing resources switch from the second mode to the first mode by switching from discarding the output of the first processing resource to discarding the output of the second processing resource, and by switching from using the output of second processing resource executing the second set of processing instructions to generate the second set of control instructions to using the output of the first processing resource executing the first set of processing instructions to generate a third set of control instructions for operating the SDV.

10. The control system of claim 9, wherein the plurality of processing resources switch from the first mode to the second mode while the SDV is continuously operational on a trip.

11. The control system of claim 9, wherein the plurality of processing resources switch from the first mode to the second mode by switching from discarding the output of the second processing resource to discarding the output of the first processing resource, and by switching from using the output of first processing resource executing the first set of processing instructions to generate the first set of control instructions to using the output of the second processing resource executing the second set of processing instructions to generate a fourth set of control instructions for operating the SDV.

12. A method for operating a self-driving vehicle (“SDV”), the method being implemented by one or more processing resources of the SDV and comprising:
(a) obtaining a current location of the SDV;
(b) selecting, based on a current location of the SDV, one of (i) an autonomous localization mode, utilizing a localization map that is stored with or accessible to the SDV, to autonomously operate the SDV, or (ii) an autonomous neural network mode, using a neural network component that implements one or more machine learning models to autonomously operate the SDV; and
(c) autonomously operating the SDV on at least a segment of a planned route using the selected one of the autonomous localization mode or the autonomous neural network mode.

13. The method of claim 12, wherein (b) includes determining whether a set of localization maps that are stored or available to the SDV are available or accurate, based on the current location.

14. The method of claim 12, wherein (b) includes determining whether a set of localization maps that are stored or available to the SDV are available or accurate, along a remainder of the planned route from the current location.

15. The method of claim 12, further comprising repeatedly receiving, while the SDV is operating on the planned route, generating an output from a corresponding control sub-system of each of the autonomous localization mode and the autonomous neural network mode.

16. The method of claim 15, wherein (c) includes controlling the SDV using the output of the corresponding control sub-system for the selected one of the autonomous localization mode or the autonomous neural network mode.

17. The method of claim 12, wherein the method further comprises:
while the SDV is operating on the planned route, switching as between one of the autonomous localization mode and the autonomous neural network mode, based on the current location of the SDV relative to a boundary of a region that is covered by a set of localization maps that are stored or available to the SDV.

18. A non-transitory computer-readable medium that stores instructions, that when executed by a set of processing instructions that are resident on a self-driving vehicle (“SDV”), cause the SDV to perform operations that include:
(a) obtaining a current location;
(b) selecting, based on a current location of the SDV, one of (i) an autonomous localization mode, utilizing a localization map, or (ii) an autonomous neural network mode, using a neural network component that implements one or more machine learning models; and
(c) autonomously operating on at least a segment of a planned route using the selected one of the autonomous localization mode or the autonomous neural network mode.

19. The non-transitory computer-readable medium of claim 18, wherein (b) includes determining whether a set of localization maps that are stored or available to the SDV are available or accurate, based on the current location.

20. The non-transitory computer-readable medium of claim 18, wherein (b) includes determining whether a set of localization maps that are stored or available to the SDV are available or accurate along a remainder of the planned route from the current location.
